(19) United States
(12) Patent Application Publication
(10) Pub. No.: US 2025/0316806 A1
(43) Pub. Date: Oct. 9, 2025

(54) SECONDARY BATTERY AND METHOD OF MANUFACTURING A SECONDARY BATTERY

(71) Applicant: SAMSUNG SDI CO., LTD., Yongin-si (KR)

(72) Inventors: In Seop BYUN, Yongin-si (KR); Ki Youn JEON, Yongin-si (KR)

(21) Appl. No.: 18/907,554

(22) Filed: Oct. 6, 2024

(30) Foreign Application Priority Data
Apr. 3, 2024 (KR) 10-2024-0045195

(51) Int. Cl. H01M 50/169; H01M 50/103; H01M 50/15; H01M 50/249

(52) U.S. Cl. CPC H01M 50/169; H01M 50/103; H01M 50/15; H01M 50/249

(57) ABSTRACT

A secondary battery includes an electrode assembly that includes a first electrode plate and a second electrode plate and a case in which the electrode assembly is received. The case includes a first case including receiving space in which the electrode assembly is received, with a part of the first case being open, and a second case configured to seal the open part of the first case. The second case includes a press-fit groove formed in a surface of the second case. An end of the first case is coupled to the press-fit groove.

### CROSS-REFERENCE TO THE RELATED APPLICATION

The present application claims priority to and the benefit of Korean Patent Application No. 10-2024-0045195, filed on Apr. 3, 2024, in the Korean Intellectual Property Office, the entire disclosure of which is incorporated herein by reference.

### BACKGROUND

### 1. Field

Embodiments of the present disclosure relate to a secondary battery and a method of manufacturing a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments of the present disclosure provide a secondary battery configured such that an unnecessary edge region is removed after a case is welded, thereby preventing unnecessary size and a decrease in energy density, and a method of manufacturing the secondary battery.

Embodiments of the present disclosure provide a secondary battery configured such that a press-fit groove is formed in a second case using an end of a first case, and the first case and the second case are welded to each other using a protrusion that is formed opposite to the press-fit groove as a welding line, thereby facilitating the manufacture of cases of various shapes.

These and other aspects and features of the present disclosure will be described in or will be apparent from the following description of embodiments of the present disclosure.

A secondary battery according to an embodiment of the present disclosure to accomplish the above objects includes an electrode assembly having a first electrode plate and a second electrode plate and a case in which the electrode assembly is received, wherein the case includes a first case having a receiving space wherein the electrode assembly is received, with a part of the first case being open, and a second case configured to seal the open part of the first case, the second case includes a press-fit groove, and an end of the first case is coupled to the press-fit groove.

The end of the first case may be in contact with the press-fit groove.

The second case may include a protrusion having a shape corresponding to the shape of the press-fit groove.

The first case and second case may be coupled to each other by welding, and a weld bead may be formed on the protrusion.

The first case may include a flat first surface and a second surface extending from an edge of the first surface in a direction toward the second case, and the press-fit groove may be formed by pressing of an end of the second surface into the second case, whereby the press-fit groove may have a shape corresponding to the shape of the end of the second surface.

The end of the second surface of the first case may be coupled to the press-fit groove of the second case by welding.

A side wall of the second case may be in the same plane as the second surface of the first case.

The press-fit groove may be stepped from the other regions of the second case.

The second case may further include a side protrusion having a side wall protruding farther than the second surface of the first case.

The press-fit groove may be concave in the surface of the second case.

The first case and the second case may be made of steel, stainless steel, nickel-plated steel, or a steel alloy.

The first case and the second case may have thicknesses of 0.05 mm to 0.4 mm.

A secondary battery manufacturing method according to an embodiment of the present disclosure to accomplish the above objects includes pressing a surface of a second case using an end of a first case to form a press-fit groove, the first case including a receiving space formed therein, one surface of the first case being open, to form a press-fit groove, coupling the first case and the second case to each other by welding in the state in which the end of the first case is received in the press-fit groove of the second case, and removing an edge region of the second case that protrudes farther than an outer surface of the first case, with the electrode assembly being positioned in the receiving space of the first case.

The second case may further include a protrusion having a shape corresponding to the shape of the press-fit groove, and the first case and the second case may be welded to each other using the protrusion as a welding line.

The edge region of the second case may be removed, whereby the second case may further include a side protrusion having a side wall protruding farther than the outer surface of the first case.

The edge region of the second case may be removed, whereby the outer surface of the first case and a side wall of the second case may be in the same plane.

The first case and the second case may be coupled to each other by laser welding.

The edge region of the second case may be removed by laser cutting or grinder cutting.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a perspective view showing a secondary battery according to an embodiment of the present disclosure;

FIG. 2 is a sectional view of the secondary battery taken along line 2-2′ of FIG. 1;

FIG. 3 is a sectional view of an electrode assembly in the secondary battery shown in FIGS. 1 and 2;

FIG. 4A is a sectional view of the secondary battery taken along line 4a-4a′ of FIG. 1 as an example;

FIG. 4B is an enlarged sectional view showing part 4b of FIG. 4A;

FIG. 5A is an exploded perspective view showing a case of the secondary battery according to the embodiment of the present disclosure before coupling;

FIG. 5B is a sectional view taken along line 5b-5b′ of FIG. 5A;

FIG. 5C is an enlarged view showing part 5c of FIG. 5B;

FIG. 6A is a sectional view of the secondary battery taken along line 4a-4a′ of FIG. 1 as another example;

FIG. 6B is an enlarged sectional view showing part 6b of FIG. 6A;

FIGS. 7A and 7B are perspective views showing a battery pack including an exemplary secondary battery according to an embodiment of the present disclosure; and

FIGS. 8A and 8B are perspective and side views showing a vehicle including an exemplary battery pack according to an embodiment of the present disclosure.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

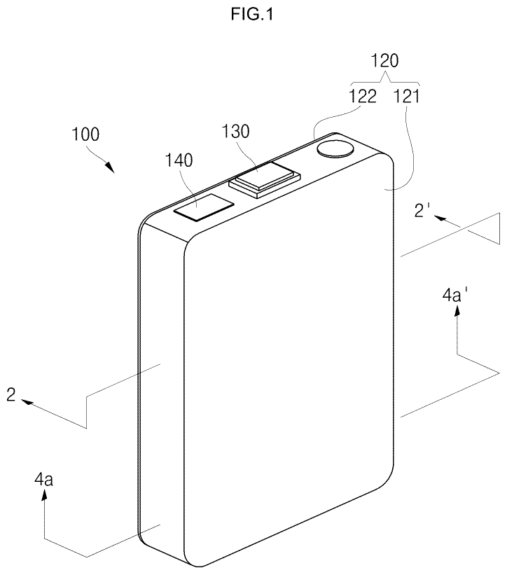

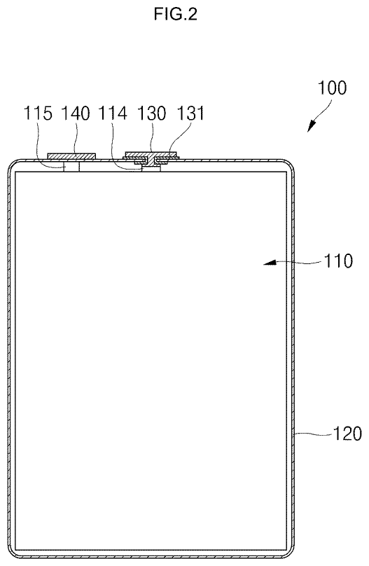

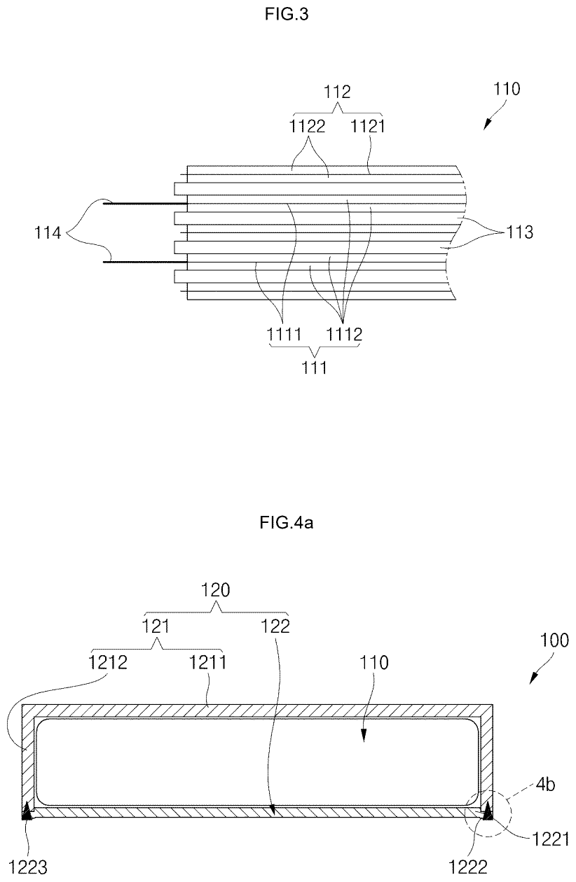

FIGS. 1 and 2 are perspective and sectional views showing an exemplary secondary battery 100 according to an embodiment of the present disclosure. FIG. 2 is a sectional view taken along line 2-2′ of FIG. 1. As shown in FIGS. 1 to 3, the secondary battery 100 according to the embodiment of the present disclosure may include an electrode assembly 110 and a case 120 configured to receive the electrode assembly 110. FIG. 3 is an enlarged sectional view showing a part of the electrode assembly 110 in the secondary battery 100 shown in FIGS. 1 and 2.

The case 120 may include a first case 121 having a receiving space and an open surface and a second case 122 coupled to the open surface of the first case 121. The case 120 may provide the external appearance of the secondary battery 100. The case 120 may include or be referred to as a can, a housing, or a cladding. The first case 121 and the second case 122 may be coupled to each other in a sealed state by welding. The case 120 may have a shape enclosing the electrode assembly 110, and the shape of the case may be changed depending on the shape of the electrode assembly 110.

The electrode assembly 110 may be received in the case 120 together with an electrolytic solution. The electrode assembly 110 may include or be referred to as an electrode group, an electrode body, or a jellyroll. The electrode assembly 110 may include first electrode plates 111, second electrode plates 112, and separators 113 disposed between the first electrode plates 111 and the second electrode plates 112. The electrode assembly 110 may be variously modified. For example, the electrode assembly 110 may be stacked into a sheet shape or may be wound into a jelly roll shape. In the electrode assembly 110, the first electrode plates 111, the separators 113, the second electrode plates 112, and the separators 113 may be alternately stacked in that order. A separator 113 or a second electrode plate 112 may be located on the outermost side of the electrode assembly 110, and the case 120 and the first electrode plates 111 may be electrically separated from each other.

Each of the first electrode plates 111 may include a first substrate 1111 and a first active material layer 1112 located on the first substrate 1111. A first non-coated portion of the first substrate 1111 on which the first active material layer 1112 is not provided, i.e., a first electrode tab 114, may extend outward, and the first electrode tab 114 may be electrically connected to a first terminal 130. Each of the second electrode plates 112 may include a second substrate 1121 and a second active material layer 1122 located on the second substrate 1121. A second non-coated portion of the second substrate 1121 on which the second active material layer 1122 is not provided, i.e., a second electrode tab 115, may extend outward, and the second electrode tab 115 may be electrically connected to a second terminal 140. The first electrode tab 114 and the second electrode tab 115 may protrude and extend outward from one side of the electrode assembly 110. The first electrode tab 114 and the second electrode tab 115 may be spaced apart from each other at one side of the electrode assembly 110. The one side of the electrode assembly 110 may be an upper side, and the first electrode tab 114 and the second electrode tab 115 may be spaced apart from each other at the upper side of the electrode assembly 110 in a longitudinal direction. In another example, the first electrode tab 114 and the second electrode tab 115 may be separate lead tabs in contact with and coupled to the first non-coated portion and the second non-coated portion of the electrode assembly 110, respectively.

The first electrode plate 111 may function as a positive electrode. In such a case, the first substrate may be made of, for example, aluminum foil, and the first active material layer may include, for example, a transition metal oxide. The second electrode plate 112 may function as a negative electrode. In such a case, the second substrate may be made of, for example, copper foil or nickel foil, and the second active material layer may include, for example, graphite. The separator 113 may prevent short circuit between the first electrode plate 111 and the second electrode plate 112 while allowing migration of lithium ions. The separator 113 may be made of, for example, a polyethylene film, a polypropylene film, or a polyethylene-polypropylene film.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth) acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The secondary battery 100 may further include a first terminal 130 and a second terminal 140 provided at an upper side of the case 120. The first terminal 130 may be electrically isolated from the case 120 and may be in contact with and electrically connected to the first electrode tab 114 of the electrode assembly 110. The first electrode tab 114 of the electrode assembly 110 may be located between the first terminal 130 and the upper side of the electrode assembly 110.

An insulating member 131 may be interposed between the first terminal 130 and the case 120. The first terminal 130 may extend through the case 120 such that an upper part of the first terminal is exposed and protrudes to outside of the case 120. The first terminal 130 may extend through the case 120 such that a lower part of the first terminal is located in the case 120, and the first electrode tab 114 of the electrode assembly 110 may be in contact with and coupled to a lower end of the first terminal 130 by welding. In some examples, the insulating member 131 may include or be referred to as a gasket. Although the insulating member 131 is shown as a single piece, the present disclosure is not limited thereto, and the insulating member may include an insulating member in contact with an outer surface of the case 120, an insulating member in contact with an inner surface of the case 120, and a gasket located in a terminal hole of the case 120.

The second terminal 140 may be in contact with and electrically connected to the case 120. The second terminal 140 may be a part of the case 120. The second terminal 140 may be electrically connected to the second electrode tab 115 of the electrode assembly 110. For example, the second electrode tab 115 may be in contact with and electrically connected to the case 120. The second terminal 140 may be electrically connected to the second electrode tab 115 of the electrode assembly 110 via the case 120. The second electrode tab 115 may be located between the second terminal 140 and the upper side of the electrode assembly 110.

The present disclosure is not limited to the example secondary battery 100 shown in FIGS. 1 to 3. For example, the case may have any of various shapes, such as a circular shape or a pouch shape.

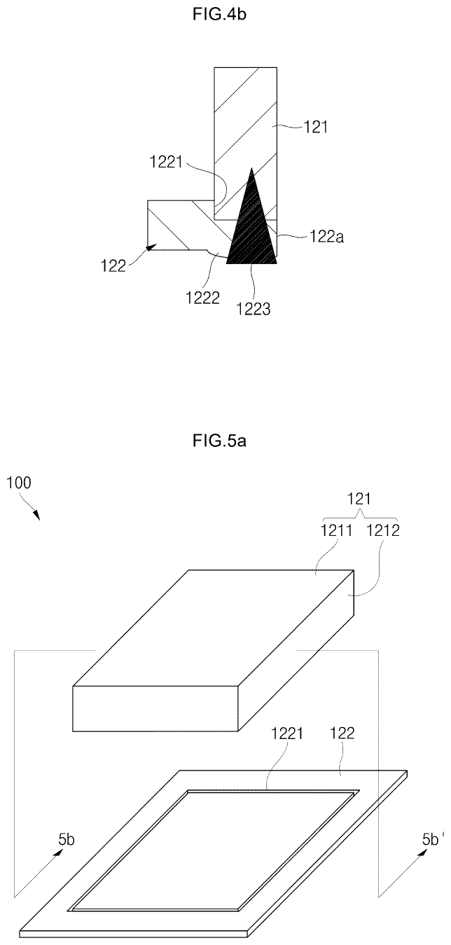

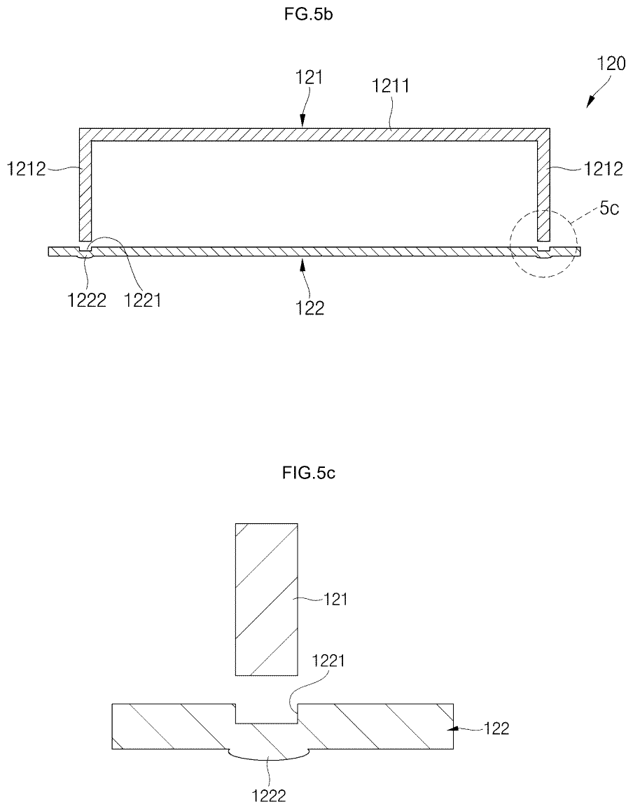

FIG. 4A is a sectional view of the secondary battery taken along line 4a-4a′ of FIG. 1 as an example, and FIG. 4B is an enlarged sectional view showing part 4b of FIG. 4A. FIG. 5A is an exploded perspective view showing the case of the secondary battery according to the embodiment of the present disclosure before coupling, FIG. 5B is a sectional view taken along line 5b-5b′ of FIG. 5A, and FIG. 5C is an enlarged view showing part 5c of FIG. 5B.

Hereinafter, the structure and coupling of the case 120 of the secondary battery 100 according to an embodiment of the present disclosure will be described with reference to FIGS. 4A, 4B, 5A, 5B, and 5C.

The case 120 may include a first case 121 formed in the shape of a cup and a second case 122 formed in the shape of a plate. Each of the first case 121 and the second case 122 may include steel, stainless steel (SUS), nickel-plated steel, or a steel alloy.

The first case 121 may include a flat first surface 1211 and a second surface 1212 extending from an edge of the first surface 1211 in a direction toward the second case 122. The first surface 1211 may be a rectangular flat surface, and the second surface 1212 may extend from four edges of the first surface 1211 so as to have a predetermined height. The second surface 1212 may have a rectangle ring shape formed by four rectangular surface parts connected to each other. The second surface 1212 may have one end connected to the first surface 1211 and the other end opposite the one end. As such, the first surface 1211 and the second surface 1212 may be integrally formed. The second surface 1212 may extend approximately perpendicularly from the edge of the first surface 1211 to minimize unnecessary inner space of the battery 100.

The first case 121 may provide a receiving space in which the electrode assembly 110 may be received, with the receiving space being defined by the first surface 1211 and the second surface 1212. The first case 121 may have a thickness of about 0.05 mm to 0.4 mm. If the thickness of the first case 121 is less than 0.05 mm, it may not be easy to maintain rigidity and to form a press-fit groove 1221 (described below) in the second case 122 by pressing. If the thickness of the first case 121 is greater than 0.4 mm, the capacity to size ratio of the secondary battery 100 may be reduced, whereby energy density may be reduced.

The second case 122 may be formed in the shape of a flat plate. The second case 122 may be provided in one surface thereof with a press-fit groove 1221 having a shape corresponding to shape of the second surface 1212 of the first case 121 in the opposite direction. The press-fit groove 1221 may be formed as the result of the second case 122 being pressed in contact with the other end of the second surface 1212 of the first case 121. The press-fit groove 1221 may have a shape similar or identical to the planar shape of the other end of the second surface 1212 of the first case 121. The second case 122 may be provided with a protrusion 1222, which is formed in a region corresponding to the press-fit groove 1221. If the press-fit groove 1221 is formed in one surface of the thin film-shaped second case 122, the other surface of the second case may protrude whereby the protrusion 1222 may be formed as result of pressing by the first case 121. The protrusion 1222 may also have a shape similar or identical to the planar shape of the other end of the second surface 1212 of the first case 121. Thus, it is possible to check the position of the second case 122 at which the second case 122 is in contact with and coupled to the first case 121 on one surface of the second case 122 through the protrusion 1222 on the other surface of the second case 122. The thickness of the region of the second case 122 having the protrusion 1222 and the press-fit groove 1221 may be less than the thickness of other regions of the second case 122 because the region is pressed by the first case 121.

The first case 121 may be coupled to the second case 122 by welding in the state in which the other end of the second surface 1212 is inserted into the press-fit groove 1221 of the second case 122. The first case 121 and the second case 122 may be welded (1223) to each other along the protrusion 1222 on the other surface of the second case 122. The second case 122 may be welded to the first case 121 using the protrusion 1222 as a welding line. In particular, the first case 121 and the second case 122 may be coupled to each other by laser welding. After the first case 121 and the second case 122 are coupled to each other, a weld bead 1223 may be located on the other surface of the second case 122. The weld bead 1223 may be provided along the protrusion 1222 of the second case 122. After the first case 121 and the second case 122 are coupled to each other by welding, an edge region of the second case 122 protruding outward from the second surface 1212 of the first case 121 may be removed. The edge region of the second case 122 may be removed by laser cutting or grinder cutting. The unnecessary edge region of the second case 122 may be removed to reduce the size of the case 120 and increase the energy density of the battery.

If the edge region of the second case 122 is removed, a part of an edge region of each of the press-fit groove 1221 and the protrusion 1222 may also be removed. The press-fit groove 1221 may be open in an outward direction. The press-fit groove 1221 of the second case 122 in contact with and welded to the first case 121 may be stepped from the other regions of one surface of the second case 122 in a direction toward the other surface of the second case. A cut side wall 122a of the second case 122 may be in the same plane as the outer surface of the second surface 1212 of the first case 121. Because the press-fit groove 1221 of the second case 122 may be pressed by the first case 121, the press-fit groove may have a shape corresponding to the shape of the second surface 1212 of the first case 121, whereby easy contact and adhesion between the first case 121 and the second case 122 may be achieved.

Although the first case 121 is shown and described as a cuboid with one side open, the shape of the first surface 1211 may be changed depending on the shape of the desired battery. For example, if the first surface 1211 has a circular shape, a polygonal shape, or a quadrangular shape with a part removed, a press fit groove 1221 of the same shape may be formed in the second case 122, and the first case and the second case may be coupled to each other by welding. The shape of the case 120 may be also changed depending on the shape and disposition of the electrode assembly 110.

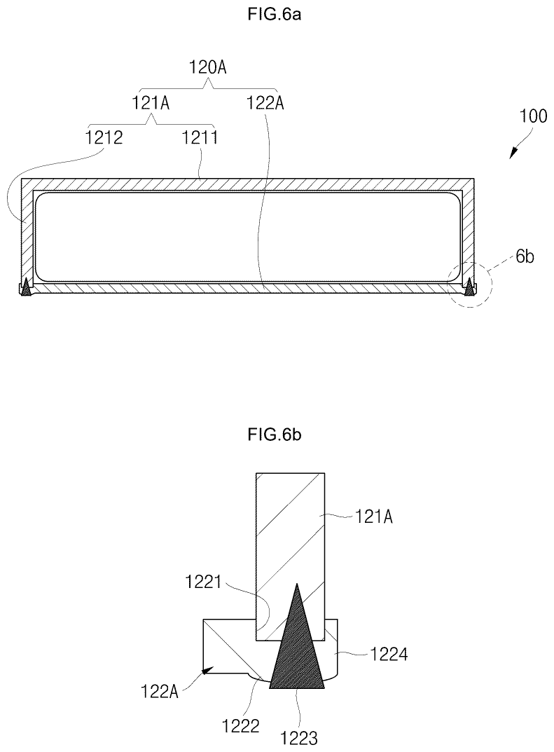

FIG. 6A is a sectional view of the secondary battery taken along line 4a-4a′ of FIG. 1 as another example, and FIG. 6B is an enlarged sectional view showing part 6b of FIG. 6A. A case 120A of the secondary battery 100 in this example may be similar in structure and manufacturing method to the case 120 of the secondary battery 100 shown in FIGS. 4A, 4B, 5A, 5B, and 5C.

However, a second case 122A of the case 120A may further include a side protrusion 1224. The second case 122A may protrude farther than the outer surface of the second surface 1212 of the first case 121 due to the side protrusion 1224. If an edge region of the second case 122A is removed, the edge region may be cut so as to be spaced apart outward from the press-fit groove 1221 and the protrusion 1222 to provide the side protrusion 1224. The thickness of the side protrusion 1224 may be similar to the thickness of the other regions of the second case 122A. The press-fit groove 1221 may be concave from one surface of the second case 122A in a direction toward the other surface of the second case. The side protrusion 1224 may protrude outward from the indentation 1221 and the protrusion 1222. As such, the unnecessary edge region of the second case 122A may be removed to reduce the size and increase the energy density of the secondary battery 100.

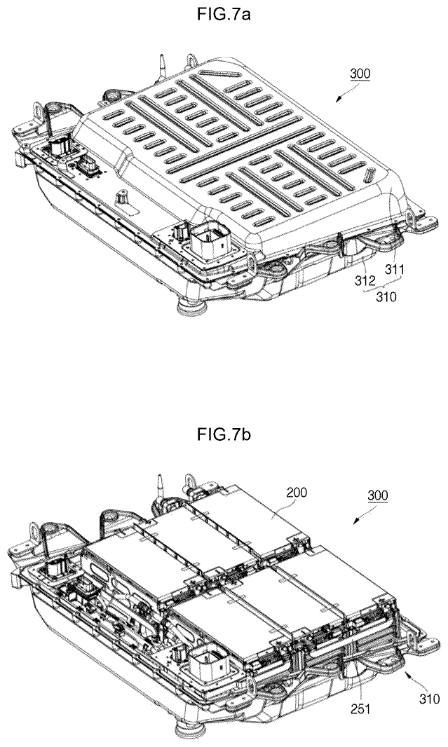

FIGS. 7A and 7B are perspective views showing an exemplary battery pack 300. The battery pack 300 may include a plurality of battery modules 200 and a housing 310 configured to accommodate the plurality of battery modules 200. For example, the housing 310 may include a first housing 311 and a second housing 312, which are coupled to each other in directions facing each other with the plurality of battery modules 200 interposed therebetween. The plurality of battery modules 200 may be electrically connected to each other using bus bars 251. The plurality of battery modules 200 may be electrically connected to each other in series, in parallel, or in a combination thereof, so that desired electrical output may be obtained.

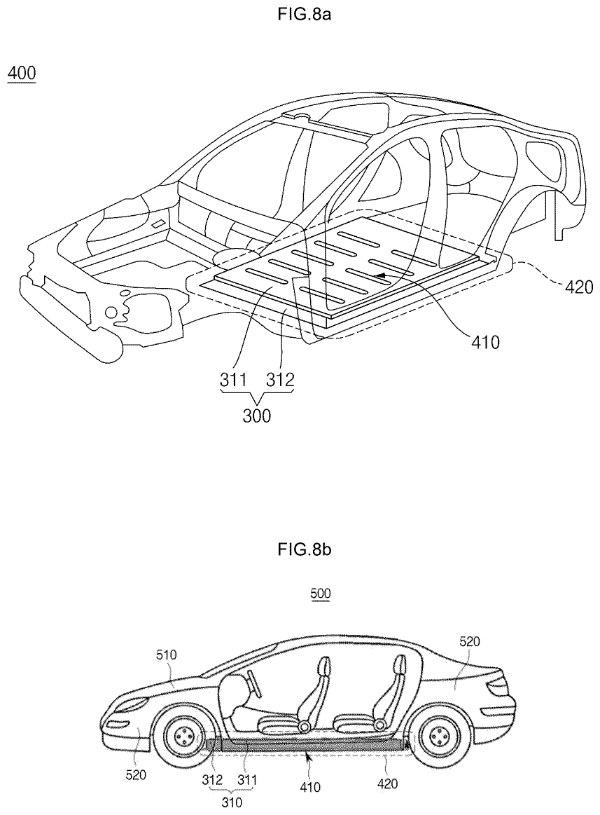

FIGS. 8A and 8B are, respectively, a perspective view showing an exemplary vehicle body 400 and a side view showing an exemplary vehicle 500. As shown in FIG. 8A, the battery pack 300 may include a battery pack cover 311 (which may correspond to the first housing), which is a portion of a vehicle underbody 410, and a pack frame 312 (which may correspond to the second housing), which is disposed beneath the vehicle underbody 410. The battery pack cover 311 and the pack frame 312 may be integrally formed with a vehicle bottom portion 420. The vehicle underbody 410 may separate the interior and the exterior of the vehicle from each other, and the pack frame 312 may be disposed outside the vehicle.

As shown in FIG. 8B, the vehicle 500 may include a vehicle body 400 and various parts coupled to the vehicle body 400, such as a hood 510 located at the front portion of the vehicle and fenders 520 located at the front and rear portions of the vehicle. The vehicle 500 may include the battery pack 300 including the battery pack cover 311 and the pack frame 312, and the battery pack 300 may be coupled to the vehicle body 400.

As is apparent from the above description, embodiments of the present disclosure provide a secondary battery configured such that a press-fit groove is formed in a second case using an end of a first case, and the first case and the second case are welded to each other using a protrusion formed opposite the press-fit groove as a welding line, thereby facilitating the manufacture of cases of various shapes, and such that an unnecessary edge region is removed after the first case and the second case are welded to each other, Thus, a secondary battery can be formed with a reduced size and increased energy density, and a method of manufacturing the secondary battery is provided.

However, the aspects and features of the present disclosure are not limited to those described above, and other aspects and features not expressly described herein will be clearly understood by a person skilled in the art from the description of example embodiments of the present disclosure described below.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly including a first electrode plate and a second electrode plate; and
a case in which the electrode assembly is positioned, wherein the case comprises:
a first case including a receiving space in which the electrode assembly is received, with a part of the first case being open; and
a second case configured to seal the open part of the first case, the second case including a press-fit groove formed in a surface of the second case, and
wherein an end of the first case is coupled to the press-fit groove.

2. The secondary battery as claimed in claim 1, wherein the end of the first case is in contact with the press-fit groove.

3. The secondary battery as claimed in claim 1, wherein the second case includes a protrusion having a shape corresponding to a shape of the press-fit groove.

4. The secondary battery as claimed in claim 3, wherein the first case and second case are coupled to each other by welding, and a weld bead is formed on the protrusion.

5. The secondary battery as claimed in claim 1, wherein the first case comprises a flat first surface and a second surface extending from an edge of the first surface in a direction toward the second case, and
wherein the press-fit groove is formed by pressing an end of the second surface into the second case, whereby the press-fit groove has a shape corresponding to a shape of the end of the second surface.

6. The secondary battery as claimed in claim 5, wherein the end of the second surface of the first case is coupled to the press-fit groove of the second case by welding.

7. The secondary battery as claimed in claim 5, wherein a side wall of the second case is in the same plane as the second surface of the first case.

8. The secondary battery as claimed in claim 7, wherein the press-fit groove is stepped from the other regions of the second case.

9. The secondary battery as claimed in claim 5, wherein the second case further comprises a side protrusion having a side wall protruding farther than the second surface of the first case.

10. The secondary battery as claimed in claim 9, wherein the press-fit groove is concave in the surface of the second case.

11. The secondary battery as claimed in claim 1, wherein the first case and the second case is made of steel, stainless steel, nickel-plated steel, or a steel alloy.

12. The secondary battery as claimed in claim 1, wherein the first case and the second case have thicknesses of 0.05 mm to 0.4 mm.

13. A secondary battery manufacturing method comprising:
pressing a surface of a second case using an end of a first case to form a press-fit groove, the first case including a receiving space formed therein;
coupling the first case and the second case to each other by welding in a state in which the end of the first case is received in the press-fit groove of the second case; and
removing an edge region of the second case that protrudes farther than an outer surface of the first case,
wherein an electrode assembly is positioned in the receiving space of the first case.

14. The secondary battery manufacturing method as claimed in claim 13, wherein the second case further comprises a protrusion having a shape corresponding to a shape of the press-fit groove, and
wherein the first case and the second case are welded to each other using the protrusion as a welding line.

15. The secondary battery manufacturing method as claimed in claim 13, wherein the edge region of the second case is removed, whereby the second case further comprises a side protrusion having a side wall protruding farther than the outer surface of the first case.

16. The secondary battery manufacturing method as claimed in claim 13, wherein the edge region of the second case is removed, whereby the outer surface of the first case and a side wall of the second case are in the same plane.

17. The secondary battery manufacturing method as claimed in claim 13, wherein the first case and the second case are coupled to each other by laser welding.

18. The secondary battery manufacturing method as claimed in claim 13, wherein the edge region of the second case is removed by laser cutting or grinder cutting.

19. A secondary battery manufactured by the secondary battery manufacturing method as claimed in claim 13.
